(19) United States
(12) Patent Application Publication
(10) Pub. No.: US 2026/0245361 A1
(43) Pub. Date: Aug. 20, 2026

(54) METHOD OF USING AUGMENTED REALITY AND IN-SITU CAMERA FOR MACHINE LEARNING INSIDE A PLANT ENVIRONMENT

(71) Applicant: Ferme d’Hiver Technologies Inc., Vaudreuil-Dorion (CA)

(72) Inventor: Yves D'AOUST, Saint-Lambert (CA)

(21) Appl. No.: 19/161,991

(22) PCT Filed: Mar. 8, 2024
(86) PCT No.: PCT/CA2024/050293

§ 371 Date: Sep. 3, 2025

Related U.S. Application Data
(60) Provisional application No. 63/450,846, filed on Mar. 8, 2023.

(51) Int. Cl. G06V 20/10; A01G 7/00; B25J 9/16; G06V 10/764; G06V 20/20; G06V 20/40

(52) U.S. Cl. CPC G06V 20/188; A01G 7/00; B25J 9/163; G06V 10/764; G06V 20/20; G06V 20/41

(57) ABSTRACT

A system and a method for analyzing a plant environment. The system comprises an augmented reality (AR) camera configured to capture video of a plant while an operator manipulates the first plant and to provide the video to a processor; an image database configured to store images and/or video of the plant collected by the AR camera, a processor having a training module and configured to execute instructions to analyze the video and to provide instructions regarding how to manipulate a second plant. Real-time validation of classifications by the system are used to continuously train the system. Movements made to perform said validation, to acquire visual data on the plant or to act on the plant are recorded for training on movement replication. These instructions to replicate a movement of plant manipulation can be provided to an AR apparatus of a second operator or to a robotic manipulator.

### RELATED APPLICATION

The present patent application claims priority to, or benefit from, U.S. provisional Patent Application No. 63/450,846, filed Mar. 8, 2023, which is incorporated herein by reference in its entirety.

### TECHNICAL FIELD

The present disclosure relates to plant growing environment. More specifically, it relates to using augmented reality for analyzing and improving plant growing process and reuse agronomical practical knowledge for use by other workers or by a robot.

### BACKGROUND

A process of growing plants is related to many stages, diseases and needs elaborative and continuous analysis of stems, flowers, fruits, leaves, pests, fungus, etc. Such analysis is usually done by agronomists or other skilled workers who can, by examining a plant in a plant growing facility, may decide to adjust conditions, such as, for example, climate and lighting conditions, of the plant growing facility in order to improve, growth of the plant.

Workers performing agricultural tasks are present everyday in the field or in the growing facility, and are among the plants where visual data may be gathered, but may lack the knowledge to act on the visual data or to detect anomalies.

### SUMMARY

It is an object of the present disclosure to provide a system and a method for analyzing of plant development and health and of manipulation of plants and automation of manipulation of the plants using augmented reality.

According to an aspect of the present disclosure, there is provided a system for analyzing a plant environment comprising:
an augmented reality (AR) camera configured to capture video of at least one element of a plant while a first operator manipulates the plant and to provide the video to a processor;
an image databased configured to store the video;
a processor having a training module and configured to execute instructions to:
   receive video from the AR camera;
   to store video in the image database;
   to classify the video, to analyze the video by determining parameters of the at least one element of the first plant; and
   to train a machine learning module to recognize types of the at least one element of the first plant, to determine parameters of the plant based on adjustments received from the first operator during recording of the video.

According to an embodiment, wherein the processor is further configured to receive a validation from the first operator upon executing the instructions to classify the video, wherein executing the instructions to train the machine learning module uses for training said validation as received.

According to an embodiment, the processor is further configured to receive video from the AR camera in a process to receive the validation from the first operator, in order to record a movement performed by the first operator leading the validation.

According to an embodiment, the processor is further configured to execute instructions to train the machine learning module to replicate said movement performed by the first operator leading the validation.

According to an embodiment, in view of having trained the machine learning module to replicate said movement, the processor is further configured to provide instructions regarding how to manipulate a second plant and determining parameters of the second plant based on a machine learning data received from the machine learning module, when the second plant is manipulated, the first plant and the second plant having one plant type.

According to an embodiment, there is further provided means for sending the instructions to an augmented-reality apparatus of a second operator for movement replication by the second operator.

According to an embodiment, there is further provided a robotic manipulator configured to manipulate the second plant, and wherein the processor is configured to provide said instructions regarding how to manipulate the second plant to the robotic manipulator to manipulate the second plant.

According to an aspect of the present disclosure, there is provided a method for analyzing a plant environment, the method configured to be implemented by an augmented reality (AR) camera configured to capture video of at least one element of a plant while a first operator manipulates the plant and to provide the video to a processor;
an image databased configured to store the video; and
a processor having a training module and configured to execute instructions of the method, the method comprising:
   receiving a video from the AR camera;
   storing the video in the image database;
   classifying the video, analyzing the video by determining parameters of the at least one element of the first plant; and
   training a machine learning module to recognize types of the at least one element of the first plant, to determine parameters of the plant based on adjustments received from the first operator during recording of the video.

According to an embodiment, there is further provided a step of receiving a validation of said classifying the video from the first operator, wherein training the machine learning module uses said validation as received to perform the training.

According to an embodiment, there is further provided a step of receiving video from the AR camera in a process to receive the validation from the first operator, in order to record a movement performed by the first operator leading the validation.

According to an embodiment, there is further provided a step of training the machine learning module to replicate said movement performed by the first operator leading the validation.

According to an embodiment, there is further provided a step of, in view of training the machine learning module to replicate said movement, providing instructions regarding how to manipulate a second plant and determining parameters of the second plant based on a machine learning data received from the machine learning module, when the second plant is manipulated, the first plant and the second plant having one plant type.

According to an embodiment, there is further provided a step of sending the instructions to an augmented-reality apparatus of a second operator for movement replication by the second operator.

According to an embodiment, there is further provided a step of using a robotic manipulator configured to manipulate the second plant, and providing said instructions regarding how to manipulate the second plant to the robotic manipulator to manipulate the second plant.

### BRIEF DESCRIPTION OF THE DRAWINGS

Further features and advantages of the present disclosure will become apparent from the following detailed description, taken in combination with the appended drawings, in which:

FIG. 1 is a schematic block diagram of a system for augmented reality in a plant environment, in accordance with at least one embodiment of the present disclosure;

FIG. 2 is a schematic view of an in-situ display for analyzing the status of a plant growing process and health, in accordance with at least one embodiment of the present disclosure;

FIG. 3 is a schematic block diagram of the system for augmented reality in a plant environment, in accordance with at least one embodiment of the present disclosure; and

FIG. 4 is a schematic view of an in-situ display for analyzing the status of a plant growing process and health, in accordance with at least one embodiment of the present disclosure, wherein the movement as in FIG. 2 is being replicated, for instance by a robotic manipulator;

It will be noted that throughout the appended drawings, like features are identified by like reference numerals.

### DETAILED DESCRIPTION

Various aspects of the present disclosure generally address one or more of the problems of plant growing facilities and a plant growing process.

The present description provides a system and a method for using machine learning in a plant growing environment, which could be a vertical farming facility, a greenhouse or out in the field. The method uses an augmented reality apparatus and an in-situ camera (e.g., a wearable camera) for machine learning inside the plant environment.

As referred to herein, a “plant growing environment” or a “plant environment” may be any environment where the plants may be grown, such as, for example, and without limitation, a plant growing facility, outdoor (e.g., a field) or indoor (e.g., greenhouse), such as a vertical agriculture facility.

As referred to herein, a “plant” comprises any type of plant, such as, for example, and without limitation, stems, fruits, berries, mushrooms. The plant may be, for example, a strawberry plant. Two strawberries belong to or define one “plant type”. Two mushrooms belong to or define another “plant type”.

As referred to herein, a “fruit” comprises a fruit, a berry, a mushroom, an apple, a strawberry, or any other eatable or not eatable part of a plant that is intended to be grown and collected.

As referred to herein an “observed element” or an “element of the plant” comprises pests, fungi, deficiencies, leaf development, fruits, flowers, runners, etc.

As referred to herein, an “environment condition” comprises, and is not limited to air temperature, air humidity, CO₂ level, soil moisture, light intensity and light spectrum, etc., which is measurable and which can be acted upon.

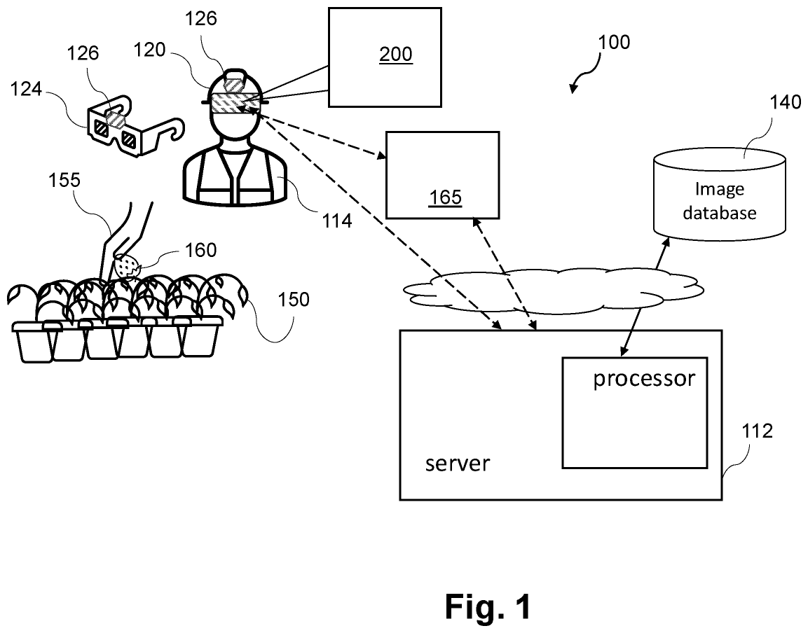

Referring now to the drawings, FIG. 1 depicts a system 100, in accordance with at least one embodiment of the present disclosure. The system 100 comprises a main processor 110 that may be stored in a server 112, which can be a remote server accessible through a telecommunication network. The main processor 110 is in communication with a video-recording device 120, which can be a wearable camera, and at least one database, such as, for example, an image database 140.

The video-recording device 120 may be portable. An operator 114 may have (is equipped with) the video-recording device 120. For example, and without limitation, the video-recording device 120 (also referred to herein as an “AR headset”) may be installed in or be part of a helmet 122 (also referred to herein as an “AR helmet”) and/or glasses 124 (also referred to herein as an “AR glasses”). Such a headset, helmet or glasses (i.e., AR apparatus) implementing augmented reality (AR) can provide additional text, data, images or any other visual information or indication in superimposition (or overlay) with the environment viewed in the field of view of the user wearing such an AR apparatus. The video-recording device 120 is configured to implement AR methods. In at least one embodiment, the video-recording device 120 comprises or is a camera 126 that is configured to operate as an AR camera.

The camera 126 is configured to capture video (and/or images), store them on a camera database 128 and transmit the captured video and/or image data to the server 112, or to process them locally by a camera processor 130.

In addition to the camera 126, in at least one embodiment, the video/image-recording device 120 also has a display 125 which is configured to overlay the images captured by the camera 126 with various data received from the video-image database 140 and/or another database of the system 100.

According to an embodiment of the disclosure, the video/image-recording device 120 and/or the display 125 is operatively coupled with an interface for classifying the elements we wish to observe (pests, fungi, deficiencies, leaf development, fruits, flowers, runners, etc.), for example by a user, said classification being used to train a machine-learning algorithm to perform such a classification autonomously afterwards based on the training thereof. In at least one embodiment, a workstation where the classification is performed is a part of the server 112 in FIG. 1.

In at least one embodiment, the video/image database 140 may be built and then used during the operation of the system 100. The video/image database 140 is configured to store specific information related to analysis of the plants.

In at least one embodiment, the system may index peculiarities in the plant. For example, the operator with the AR headset 120 sees the plant 150, as well as an AR interface used to index in the image. In other terms, the AR headset 120 displays to the operator the AR interface overlayed on a semi-transparent surface of AR headset 120 through which the plant is visible. In at least one embodiment, the AR headset 120 presents, in the area seen by the operator's eyes, an in-situ real time video of the plant overlayed over the AR interface. A highlighted section of the plant that is visible to the operator may be displayed with information (such as, for example, the detection of a pest). This information is then confirmed by the operator. This positive or negative confirmation, also known as a validation, can be made in real-time by the operator, thereby serving as an input for training a machine learning algorithm and thereby improving the accuracy of classification over time as the result of the validation by the operator can immediately correct any mistake, the frequency of such misclassifications decreasing over the number of data being treated and validated on the fly.

The operator 114 may activate, with his/her hand(s) 155, a device (pointer, mouse, touch screen device, etc.) or by vocal instructions, a menu of the AR interface that allows him/her to select a “use case” corresponding to an observed element of the plant (for example, fruit or flower), to identify/delimit an area of the image that represents this use case. The operator 114 may then confirm (validate) the indexing and the system saves it based on the operator's confirmation. The AR interface (graphical user interface) prompts the user to select the use case and confirm it.

The image analysis may be also validated by the system 100. The operator 114 with the AR headset 120 sees the plant as well as the AR interface. The AR interface is used by the operator to validate the interpretation that image analysis makes of the plant in front of the operator and seen in the helmet or through the glasses or handheld device, for example. With the operator's hand, the operator activates a menu in the AR interface that prompts the operator to select a validation menu of the use cases observed by the image analysis system. According to an embodiment of the disclosure, the AR application identifies/delimits with a graphic overlay in the headset or handheld device a section of the plant representing a specific use case corresponding to the observer element 160 of the plant (e.g., fruit or flower), and prompts the operator to validate this use case and confirm the indexing. The system then saves selection of the use case and maps the use case with the collected video-image stored at the video-image database, this mapping between the video or image(s) and the classification being used for training the algorithm to perform classifications in the future.

In at least one embodiment, the flowers and fruits and their status in the growth cycle of the plant may be auto-detected, for example by using a pre-trained machine learning algorithm, or using an expert system implementing machine vision. For example, such auto-detection may be used for image triggering. The use cases related to image analysis of flowers and fruits, their growth stage at that time, or other elements of the plants may be, for example, and without limitations: pests, fungi, symptoms indicative of deficiencies in specific nutritive substances, fruit load per stem, size and maturity, crop projection, etc. The system 100 may pre-identify specific elements in the image (such as flowers, fruits, spores, leaves, etc.) in order to trigger an automatic image taking and tagging. The system 100 is configured to train the system to be able to identify elements of the image and to automatically record the data (image, video, parameters of the element and its portion(s)). The user, if a domain expert, may then make corrections or approve the suggestion.

The system and methods as described herein help to validate and to confirm the quality of the images captured automatically. Thus, the operator with the AR headset, in the field of view, sees the plant as well as an AR interface used to validate the identification of the detection area and the quality of the video-image captured. Using the operator's hand, the operator activates a menu that prompts the operator to select the use case (such as, for example, automatic detection of fruits and/flowers), to validate the area(s) of the image that represents this use case, and to confirm the indexing, and then the system, after having received the operator's input, saves the operator's input in the database. Another menu may be available to display the image captured, so that the operator can see and is prompted to validate the quality of the image. Such validation helps, for example, making sure that the speed of image taking does not affect the quality of the image in spite of a movement of the camera during a normal course of an operator's work.

The system 100 is configured to train, qualify, integrate into operations and report the data. The system and the method as described herein will greatly help to simplify the image taking, indexing, training and validation of the use cases.

In at least one exemplary embodiment of the disclosure, the system may train itself about the manipulation of the plants, by observing the hands of operators. For example, based on the observation of the hands and fingers of the operators, the system may get trained to automate various operator's tasks, such as, for example, and without limitation, cutting runners, removing leaves, cutting flowers, cutting deformed fruits, and pick strawberries. Performing each operator's task may comprise performing a set of manipulations, in a specific and non-limiting example with their hand(s), such as turning, moving, holding the plant, flower or fruit, moving leaves to reveal a specific location on the plant (e.g., the stem or bottom surface of a leaf), etc.

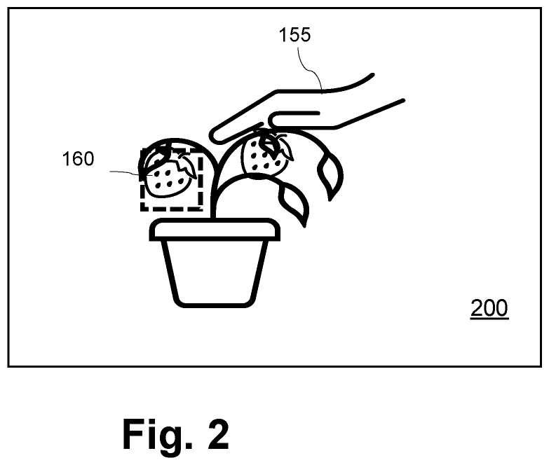

Advantageously, the system may record and classify the combination of arm, hand and finger movements of the operator to perform a specific task, including manipulation of a leaf, of a flower, or of a fruit for observation. Accordingly, the system may learn which movement is required to make such an observation used for the step of operator's validation described above. This will help train and instruct a robotic manipulator to perform manipulations for a better classification of leaf, flower or fruit feature classification. For example, the system may first try to identify (i.e., suggest) a disease on a leaf, as per the initial training of the system, then observe the movement made by the operator which is made by the operator to confirm the system's suggestion. The operator then validates whether the leaf has such a disease or not. In the process, the system will have learned not only the confirmation by the operator, but will also have learned the movement made by the operator who knows where to look more in detail to make the confirmation. See the hand 155 of FIG. 2, being filmed to acquire visual data indicative of the movement required by an operator to arrive at any validation or acquisition of additional visual data of the plant, which the system records and uses for next-level training as to generate instructions of what to do to make a validation. In a future iteration in which the camera is associated with a robotic manipulator, the system may then suggest (or suspect) a disease, instruct another less knowledgeable operator or the robotic manipulator to perform the same manipulation on the plant and acquire further information to have the less knowledgeable operator or the robot validate the suggestion using the new information acquired by the camera following the instructed manipulation of the robotic manipulator replicating what the human operator would have done to confirm the suggestion.

The system may request the operator to turn the plant or to move towards a certain position in order to take various views of the plant or the element of the plant. The system may collect and classify videos and other data regarding shape of the plant element, malformation, color spots, etc. Information regarding the state of the plant, the type of the plant, use case, manipulations performed by the operator are collected and stored in the image database.

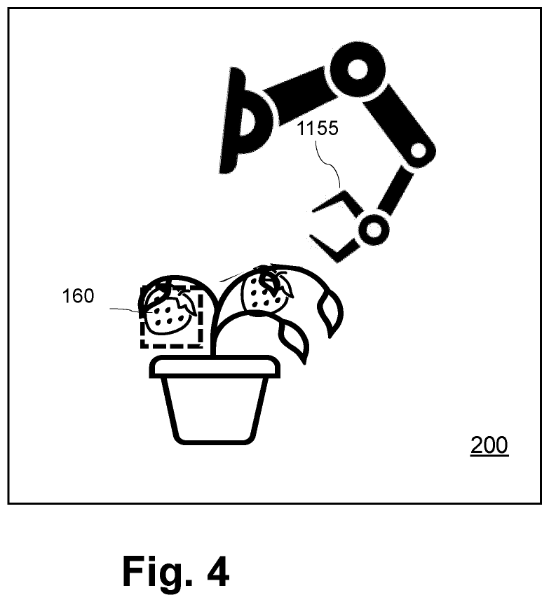

In at least one embodiment, the system has a manipulator (also referred to herein as a “robotic tool”), which is not human, that is configured to perform the operator's tasks that were previously executed by a human operator. The manipulator should comprise members which are articulated to perform relative movements between them, such as a pivot or spinning about the articulation or rotation of translation of the manipulator, and any combination of such movements to provide the most degrees of freedom as possible or required for the manipulator to replicate human arm and hand movement. Power is provided to activate actuators or the like to perform the articulated movement of the members of the manipulator. Preferably, the manipulator comprises equivalent of an elbow, of a wrist, and of fingers for the manipulator to replicate human arm and hand movement as monitored by the wearable camera. See for example the robotic manipulator 1155 of FIG. 4 which replicates the human hand movement of FIG. 2. The manipulator may be trained by the system by filming and recording the operation of the operator's hands (manipulations), saving the video of the operation in the database, analyzing the videos, and training the manipulator's operating unit. The manipulator's operating unit may be trained and then operate the manipulator to perform/execute the formerly operator's tasks, such as, for example, and without limitation, cutting runners, removing leaves, cutting flowers, cutting deformed fruits, and pick fragile fruit such as individual strawberries. In other words, by filming the operator's hands and fingers over time manipulating parts of the plant or fruit, the kinematics of the operator's hands and fingers can be tracked over time and recorded. Again, a real-time validation on the fly may help training the system, e.g., if the replicated manipulation ended up in crushing a picked strawberry, this information (the crushing) can be identified by the camera or entered by the operator so that the machine learning algorithm for the replication of manipulation will learn that the manipulation ended up with such a negative conclusion and this validation of result will be fed to the on-the-fly training of the algorithm.

The system as described herein is configured to train itself using machine learning in analysis and manipulation. Based on such a training, the system is configured to generate and deliver instructions to the robotic tool to execute (perform) various manipulations with the plant, i.e., by replicating the kinematics of the operator's hands and fingers that was tracked over time and recorded, to have the robotic tool having appropriate implements (i.e., hand-like or finger-like robotic implements being actionable to replicate hand and finger movements in general) perform the same movements based on instructions that put into action said replication of the kinematics of the operator's hands and fingers in order to replicate a given task, typically performed by the operator but now to be performed by the robotic tool. The system is also configured to validate the manipulations, whether human or robotic, by observing them using AR. For robotic movements, a correction of the servomechanical instructions sent to the robotic tool can be made to ensure the movement being performed is proper. For human movements, an alert or a prompt inviting the operator to correct their movement can be performed. Such use of the AR in the plant environment may significantly help to improve quality and quantity of products produced at the plant environment and improve efficiency and profitability of plant environment, such as, for example, vertical farms.

The video camera may be located in a helmet and/or in glasses and/or on the worker's uniform such as, for example, a body camera. The system may comprise a display configured to display simultaneously AR menu, AR data, and at least a portion of the plant in real time. The display may be a wearable display and/or handheld device. The AR device may comprise at least one camera and at least one display. Each eye of the operator may see (may be assigned to) one display or one portion of the AR device.

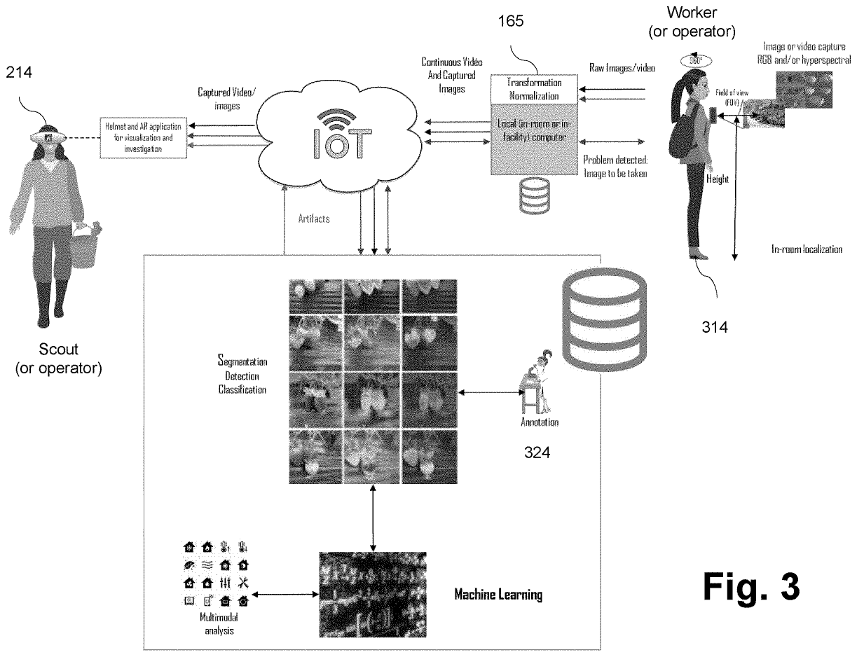

FIG. 3 illustrates a schematic block diagram of the system and execution of the method for augmented reality in a plant environment, in accordance with at least one embodiment of the present disclosure. The execution of the method is illustrated when an operator 214 (or a scout 214) who identifies and participates in the analysis of the plants and a worker 314 who is working with the plants. For example, the scout may be a highly trained specialist (such as, for example, the agronomist). The scout manipulates a first plant. The worker 314 may have low qualification with regards to analyzing plants and the plant growing processes. The worker 314 may manipulate a second plant, the first plant and the second plant having one plant type (for example, both the first and the second plants are strawberries). In some embodiments, the scout and the worker may be the same person, while when referred to as the “scout”, the operator manipulates a first plant, and when referred to as “worker”, the operator manipulates a second plant, the first plant and the second plant having one plant type. The worker or second operator may be less knowledgeable than the first operator on which recording of movement and validations were made. The movement instructions may be sent to the AR apparatus to this second user for execution instead of to the robotic manipulator 1155.

Referring to FIG. 3, a scout 214 (in some embodiments, the operator) makes observation rounds by looking at the plants through the AR system. When the scout 214 detects a flower or fruit with white or thrips (insects), the scout activates an image taking procedure (image taking module) and identifies the anomaly observed through the AR system. The AR headset allows a 360° visualization and, combined with the position in the room and the position of the plants, offer several degrees of freedom.

The worker 314 (who may be the operator or another person), when picking or performing maintenance, moves the foliage of the plants to find the fruits, flowers, leaves etc. A location module of the system 100 identifies (“tracks”) and records the position of the worker in a room constantly. A worker-worn camera 226 records the images or a video or a scene in front of the worker 314 either continuously (high-resolution video) or manually when the worker 314 detects a problem (photos) or possibly automatically. The worker-worn camera 226 (for example, a camera processor and a camera database located inside or with the worker-worn camera 226) continuously analyses the scene with the plant and automatically triggers capturing video (“shooting”) of a problem. The image or video is captured in RGB (red-green-blue visible-color set) and/or hyperspectral format.

In at least one embodiment, the accumulated visual information (such as raw images and/or video) is transmitted to and collected by a computer 165 (which may be, for example, a local computer, such as an in-room or in-facility computer) via Wi-Fi or by download at the end of the activity of the worker or operator. The computer performs normalization operations and transmits the resulting images to the server 112 via, for example, an internet of things platform. Alternatively, and as discussed above, the images may be transmitted directly to the server 112 from the camera 126 (and/or video-recording device 120). The manager or an annotator 324 may help to annotate the images received by the server in response to prompts displayed. Segmentation, detection and classification is applied to the images received by the server. Machine learning module performs a multimodal analysis.

The images are analyzed by image processing module(s) at the server and perform a preliminary diagnosis. The results of the analysis are part of the data transmitted to a manager, who can see the video or images analyzed with the identified artifacts on a terminal or tablet. In other words, the system is configured to display, at a manager computer, results of the analysis performer by the system. If necessary, the manager can, for example, go (walk) to the relevant plant to confirm the diagnosis with the support of the AR. If no problem is detected based on the manager's analysis, the images are stored and accumulated for training and statistics purposes.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A system for analyzing a plant environment comprising:
an augmented reality (AR) camera configured to capture video of at least one element of a plant while a first operator manipulates the plant and to provide the video to a processor;
an image database configured to store the video;
a processor having a training module and configured to execute instructions:
to receive video from the AR camera;
to store video in the image database;
to classify the video to obtain a classification, to analyze the video by determining at least one element of the first plant; and
to train a machine learning module to recognize types of the at least one element of the first plant by using the classification and to determine a status of a plant growing process and health of the plant based on operator's input received from the first operator during recording of the video.

2. The system of claim 1, wherein the processor is further configured to receive a validation from the first operator upon executing the instructions to classify the video, wherein executing the instructions to train the machine learning module uses for training said validation as received.

3. The system of claim 2, wherein the processor is further configured to receive video from the AR camera in a process to receive the validation from the first operator, and is configured to record a movement performed by the first operator leading to the validation.

4. The system of claim 3, wherein the processor is further configured to execute instructions to train the machine learning module to generate instructions to replicate said movement performed by the first operator leading to the validation.

5. The system of claim 4, wherein in view of having trained the machine learning module to generate the instructions to replicate said movement, the processor is further configured to provide instructions to manipulate a second plant and regarding determining the status of the plant growing process and health of the second plant based on a machine learning data received from the machine learning module, when the second plant is manipulated, the first plant and the second plant having one plant type.

6. The system of claim 5, further comprising sending the instructions to manipulate the second plant to an augmented-reality apparatus of a second operator.

7. The system of claim 5, further comprising a robotic manipulator configured to manipulate the second plant, and wherein the processor is configured to provide said instructions to manipulate the second plant to the robotic manipulator.

8. A method for analyzing a plant environment, the method configured to be implemented by an augmented reality (AR) camera configured to capture video of at least one element of a plant while a first operator manipulates the plant and to provide the video to a processor;
an image database configured to store the video; and
a processor having a training module and configured to execute instructions of the method, the method comprising:
receiving a video from the AR camera;
storing the video in the image database;
classifying the video to obtain a classification, analyzing the video by determining parameters of the at least one element of the first plant; and
training a machine learning module to recognize types of the at least one element of the first plant by using the classification and to determine a status of a plant growing process and health of the plant based on operator's input received from the first operator during recording of the video.

9. The method of claim 8, further comprising receiving a validation of said classifying the video from the first operator, wherein training the machine learning module uses said validation as received to perform the training.

10. The method of claim 9, further comprising receiving video from the AR camera in a process to receive the validation from the first operator, and recording a movement performed by the first operator leading to the validation.

11. The method of claim 10, further comprising training the machine learning module to generate instructions to replicate said movement performed by the first operator leading to the validation.

12. The method of claim 11, further comprising, in view of training the machine learning module to generate the instructions to replicate said movement, providing instructions to manipulate a second plant and regarding determining the status of the plant growing process and health of the second plant based on a machine learning data received from the machine learning module, when the second plant is manipulated, the first plant and the second plant having one plant type.

13. The method of claim 12, further comprising sending the instructions to manipulate the second plant to an augmented-reality apparatus of a second operator.

14. The method of claim 12, further comprising using a robotic manipulator configured to manipulate the second plant, and providing said instructions to manipulate the second plant to the robotic manipulator.
